(19) United States
(12) Patent Application Publication
(10) Pub. No.: US 2026/0355687 A1
(43) Pub. Date: Nov. 12, 2026

(54) ELECTROSPUN POLYMER-AMINO ACID COMPOSITES FOR CARBON DIOXIDE CAPTURE

(71) Applicant: Arizona Board of Regents on behalf of Arizona State University, Scottsdale, AZ (US)

(72) Inventors: Matthew Green, Phoenix, AZ (US); Mani Modayil Korah, Tempe, AZ (US); Klaus Lackner, Longmont, CO (US); Salma Ly, Tempe, AZ (US); Thiago Stangherlin Barbosa, Chandler, AZ (US)

(21) Appl. No.: 19/120,827

(22) PCT Filed: Nov. 3, 2023
(86) PCT No.: PCT/US2023/036741

§ 371 Date: Apr. 14, 2025

Related U.S. Application Data
(60) Provisional application No. 63/422,116, filed on Nov. 3, 2022.

(51) Int. Cl. B01D 53/82; B01D 53/62; D01D 5/00; D01F 1/10; D01F 6/14; D04H 1/4309; D04H 1/4382; D04H 1/728

(52) U.S. Cl. CPC B01D 53/82; B01D 53/62; D01D 5/0038; D01F 1/10; D01F 6/14; D04H 1/4309; D04H 1/43838; D04H 1/728; B01D 2251/70; B01D 2253/202; B01D 2253/25; B01D 2253/304; B01D 2253/311; B01D 2257/504; D10B 2321/06; D10B 2505/00

(57) ABSTRACT

An electrospun nanofiber composite includes nanofibers comprising one or more polymers and one or more amino acids incorporated throughout the nanofibers. Forming the electrospun nanofiber composite includes combining one or more amino acids, one or more polymers, and a solvent to yield a mixture; electrospinning the mixture to yield an electrospun nanofiber composite precursor; and heating the electrospun nanofiber composite precursor to form the electrospun nanofiber composite, wherein the one or more amino acids is incorporated throughout the electrospun nanofiber composite.

This application claims the benefit of U.S. Patent Application No. 63/422,116 filed on Nov. 3, 2022, which is incorporated by reference in its entirety.

### STATEMENT OF GOVERNMENT SUPPORT

This invention was made with government support under 80NSSC18K1508 awarded by the National Aeronautical & Space Administration. The government has certain rights in the invention.

### TECHNICAL FIELD

This invention generally relates to polymer-amino acid nanofiber composites, methods of preparing the composites using electrospinning technology, and use of the composites for capture of carbon dioxide (e.g., direct air capture).

### BACKGROUND

Direct air capture (DAC) technologies can be used to extract CO₂ directly from the atmosphere. DAC can be used to help achieve negative CO₂ emissions and to remediate the anthropogenic impact on climate. DAC can complement point-source CO₂ capture and storage (CCS), compensate for residual emissions that escape during point-source capture, and target distributed emissions.

### SUMMARY

This disclosure relates to electrospun polymer-amino acid nanofiber composites for the capture of carbon dioxide (CO₂). Examples of suitable polymers include poly(vinyl alcohol) (PVA), poly(ethylene oxide) (PEO), poly(ethylene glycol) (PEG), polyacrylamides, poly(vinyl acetate), poly(vinyl guanidine), and poly(vinyl amine). Examples of suitable amino acids include glycine and the L and D enantiomers of: alanine, arginine, asparagine, aspartic acid, cysteine, glutamic acid, glutamine, histidine, isoleucine, leucine, lysine, methionine, phenylalanine, proline, serine, threonine, tryptophan, tyrosine, valine, taurine, sarcosine, selenocysteine, and pyrrolysine. The CO₂ sorption capacity of amino acids is combined with the mechanical strength of a solid sorbent by incorporating amino acids into polymer nanofiber supports. The composites are prepared by electrospinning an aqueous solution of one or more polymers, one or more amino acids, and a surfactant onto a collector to form polymer-amino acid nanofiber mats. The electrospinning process creates a solid sorbent with a high surface area that increases the amino acid accessibility for CO₂ capture. The polymer-amino acid nanofiber composites are suitable for direct air capture (DAC) of CO₂ at ambient concentrations, and for point-source and active capture of CO₂ at concentrations higher than ambient conditions. PVA-L-Arg nanofiber composites are tested using atmospheric air with ambient CO₂ concentrations, allowing the effect of other gaseous components (e.g., oxygen and water vapor) on sorbent performance to be observed.

Although the disclosed inventive concepts include those defined in the attached claims, it should be understood that the inventive concepts can also be defined in accordance with the following embodiments.

In addition to the embodiments of the attached claims and the embodiments described above, the following numbered embodiments are also innovative.

Embodiment 1 is an electrospun nanofiber composite comprising nanofibers comprising one or more polymers and one or more amino acids incorporated throughout the nanofibers.

Embodiment 2 is the electrospun nanofiber composite of embodiment 1, wherein the one or more polymers comprise poly(vinyl alcohol), poly(ethylene oxide), poly(ethylene glycol), polyacrylamides, poly(vinyl acetate), poly(vinyl guanidine), or poly(vinyl amine).

Embodiment 3 is the electrospun nanofiber composite of embodiment 2, wherein the one or more amino acids comprise glycine, L-alanine, L-arginine, L-asparagine, L-aspartic acid, L-cysteine, L-glutamic acid, L-glutamine, L-histidine, L-isoleucine, L-leucine, L-lysine, L-methionine, L-phenylalanine, L-proline, L-serine, L-threonine, L-tryptophan, L-tyrosine, L-valine, L-taurine, L-sarcosine, L-selenocysteine, L-pyrrolysine, D-alanine, D-arginine, D-asparagine, D-aspartic acid, D-cysteine, D-glutamic acid, D-glutamine, D-histidine, D-isoleucine, D-leucine, D-lysine, D-methionine, D-phenylalanine, D-proline, D-serine, D-threonine, D-tryptophan, D-tyrosine, D-valine, D-taurine, D-sarcosine, D-selenocysteine, or D-pyrrolysine.

Embodiment 4 is the electrospun nanofiber composite of embodiment 3, wherein a weight ratio of the one or more amino acids to the one or more polymers is in a range of about 0.25:1 to 1:1.

Embodiment 5 is the electrospun nanofiber composite of embodiment 4, wherein the amino acid is L-arginine and the polymer is poly(vinyl alcohol).

Embodiment 6 is the electrospun nanofiber composite of any one of embodiments 1-5, wherein the composite is in the form of a mat.

Embodiment 7 is the electrospun nanofiber composite of any one of embodiments 1-6, wherein a mean diameter of the nanofibers is in a range of about 300 nm to about 700 nm.

Embodiment 8 is the electrospun nanofiber composite of any one of embodiments 1-7, wherein a porosity of the nanofibers is in a range of about 0% to about 50%.

Embodiment 9 is a method of forming an electrospun nanofiber composite, the method comprising:
combining one or more amino acids, one or more polymers, and a solvent to yield a mixture;
electrospinning the mixture to yield an electrospun nanofiber composite precursor; and
heating the electrospun nanofiber composite precursor to form the electrospun nanofiber composite, wherein the one or more amino acids is incorporated throughout the electrospun nanofiber composite.

Embodiment 10 is the method of embodiment 9, wherein the one or more amino acids comprise glycine, L-alanine, L-arginine, L-asparagine, L-aspartic acid, L-cysteine, L-glutamic acid, L-glutamine, L-histidine, L-isoleucine, L-leucine, L-lysine, L-methionine, L-phenylalanine, L-proline, L-serine, L-threonine, L-tryptophan, L-tyrosine, L-valine, L-taurine, L-sarcosine, L-selenocysteine, L-pyrrolysine, D-alanine, D-arginine, D-asparagine, D-aspartic acid, D-cysteine, D-glutamic acid, D-glutamine, D-histidine, D-isoleucine, D-leucine, D-lysine, D-methionine, D-phenylalanine, D-proline, D-serine, D-threonine, D-tryptophan, D-tyrosine, D-valine, D-taurine, D-sarcosine, D-selenocysteine, or D-pyrrolysine.

Embodiment 11 is the method of embodiments 9 or 10, wherein the one or more polymers comprise poly(vinyl alcohol), poly(ethylene oxide), poly(ethylene glycol), polyacrylamides, poly(vinyl acetate), poly(vinyl guanidine), or poly(vinyl amine).

Embodiment 12 is the method of any one of embodiments 9-11, wherein the solvent comprises water.

Embodiment 13 is the method of any one of embodiments 9-12, wherein the mixture further comprises a surfactant.

Embodiment 14 is the method of any one of embodiments 9-13, wherein a weight ratio of the one or more amino acids to the one or more polymers is in a range of about 0.25:1 to 1:1.

Embodiment 15 is the method of any one of embodiments 9-14, wherein electrospinning the mixture to yield an electrospun nanofiber composite precursor comprises forming a mat.

Embodiment 16 is a method of capturing carbon dioxide, the method comprising:
contacting the electrospun nanofiber composite of claim 1 with a fluid comprising carbon dioxide.

Embodiment 17 is the method of embodiment 16, wherein contacting the electrospun nanofiber composite with the fluid comprises reacting the one or more amino acids, a base, and the carbon dioxide to yield a carbamate.

Embodiment 18 is the method of embodiment 16 or 17, wherein contacting the electrospun nanofiber composite with the fluid comprises reacting the one or more amino acids, water, and the carbon dioxide to yield a bicarbonate salt.

Embodiment 19 is the method of any one of embodiments 16-18, wherein the one or more amino acids comprise L-arginine, and the bicarbonate salt comprises a guanidinium bicarbonate salt.

Embodiment 20 is the method of any one of embodiments 16-19, wherein contacting the electrospun nanofiber composite with the fluid comprises:
reacting the one or more amino acids and the carbon dioxide to yield a carbamate; and
reacting the carbamate and the one or more amino acids to yield a crystalline carbamate pair.

Embodiment 21 is the method of embodiment 20, wherein the one or more amino acids comprise L-arginine.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1A depicts the preparation of polymer-amino acid nanofiber composites for capture of CO₂ via electrospinning. FIGS. 1B and 1C show the nanofiber composites before and after heat treatment, respectively.

FIG. 2 depicts charge states of L-arginine (L-Arg) with increasing basicity.

FIG. 3 depicts reaction pathways of L-arginine with CO₂. Reactions 1)-3) depict a zwitterionic reaction mechanism. Reaction 4) depicts a termolecular reaction mechanism. Reaction 5) depicts a CO₂ reaction with a guanidinium group to form bicarbonate.

FIGS. 4A and 4B show scanning electron microscopy (SEM) images of poly(vinyl alcohol)-L-arginine (PVA-L-Arg) nanofiber composites before and after heating at 115 °C for 30 min, respectively. FIGS. 4C1A-4C4B shows SEM images of nanofiber composites with different L-Arg weight ratios. The fiber void space decreases with an increase in L-Arg loading. FIG. 4D shows the SEM image of FIG. 4B after image processing to highlight white nanofibers and black void spaces (i.e., pores). FIG. 4E shows edge detection of the pores to obtain porosity as an area fraction of black pixels to white pixels. FIGS. 4F-4I show plots of fiber diameter distribution of heated PVA control, PVA-Arg₂₅, PVA-Arg₅₀, and PVA-Arg₇₅ respectively, obtained from SEM images.

FIG. 5A shows a thermogravimetric analysis (TGA) plot of the nanofiber composites with varying L-Arg concentration. FIG. 5B shows a differential scanning calorimetry (DSC) plot of the nanofiber composites with varying L-Arg concentration shows the change in glass transition temperature (Tg) of the samples before and after heat treatment. FIG. 5C shows a DSC plot of the nanofiber composites showing a decrease in Tₘ with increasing L-Arg loading. BHT and AHT refer to before and after heat treatment, respectively. The dotted vertical line indicates the glass transition temperature (Tg) and melting point (Tₘ) of PVA AHT.

FIG. 6 shows Fourier transform infrared (FTIR) spectra of PVA-L-Arg composites. BHT and AHT refer to before and after heat treatment, respectively. Subscripts indicate the weight percentage of L-Arg with respect to PVA.

FIG. 7 shows ¹H NMR spectra of PVA-Arg₅₀, PVA-Arg₂₅, L-Arg, PVA after heat treatment, respectively. The L-Arg peak at 3.11 ppm shows up in the PVA-Arg₅₀ and PVA-Arg₂₅ spectra, indicating incorporation of L-Arg into the nanocomposite structure. The peak intensity of the L-Arg peak increases with increasing L-Arg concentration. The PVA peaks remain unchanged for the composite samples, confirming the absence of new bond formation.

FIG. 8A shows plots of closed-circuit CO₂ sorption performance for PVA-Arg₅₀ at different humidity levels. FIG. 8B shows plots of open-circuit CO₂ sorption performance of PVA-Arg nanofiber composites at different L-Arg loadings tested at 20% relative humidity. FIG. 8C shows plots of open-circuit CO₂ sorption performance of PVA-Arg₂₅ and PVA-Arg₅₀ nanofiber composites at 80% relative humidity.

FIGS. 9A and 9B show the adsorption and desorption performance, respectively, of a PVA-Arg₅₀ sample. The sample was steam regenerated prior to the adsorption cycle. The testing was done at 100% relative humidity. The subscripts show the time scale of integration.

FIG. 10A-10C show plots of Avrami, pseudo-first order, and pseudo-second order kinetic model adsorption fits, respectively, for open circuit tested samples at 80% relative humidity (RH).

FIG. 11A depicts the closed-circuit CO₂ sorption system. The closed-circuit system includes an air pump, humidity controller, a testing chamber, and an infrared gas analyzer (IRGA). FIG. 11B depicts a steam generator used for PVA-L-Arg composite sorbent activation.

FIG. 11C depicts the open-circuit CO₂ sorption system. The open-circuit includes an air compressor, humidity controller, mass flow controller (MFC), a testing chamber, and an IRGA.

### DETAILED DESCRIPTION

This disclosure describes electrospun polymer-amino acid nanofiber composites for the capture of carbon dioxide (CO₂). Examples of suitable polymers include poly(vinyl alcohol) (PVA), poly(ethylene oxide) (PEO), poly(ethylene glycol) (PEG), polyacrylamides, poly(vinyl acetate), poly(vinyl guanidine), and poly(vinyl amine). Examples of suitable amino acids include glycine and the L and D enantiomers of: alanine, arginine, asparagine, aspartic acid, cysteine, glutamic acid, glutamine, histidine, isoleucine, leucine, lysine, methionine, phenylalanine, proline, serine, threonine, tryptophan, tyrosine, valine, taurine, sarcosine, selenocysteine, and pyrrolysine. The CO₂ sorption capacity of amino acids is combined with the mechanical strength of a solid sorbent by incorporating amino acids into polymer nanofiber supports. The composites are prepared by electrospinning an aqueous solution of one or more polymers, one or more amino acids, and a surfactant onto a collector to form polymer-amino acid nanofiber mats. The electrospinning process creates a solid sorbent with a high surface area that increases the amino acid accessibility for CO₂ capture. The polymer-amino acid nanofiber composites are suitable for direct air capture (DAC) of CO₂ at ambient concentrations, and for point-source and active capture of CO₂ at concentrations higher than ambient conditions. PVA-L-Arg nanofiber composites are tested using atmospheric air with ambient CO₂ concentrations, allowing the effect of other gaseous components (e.g., oxygen and water vapor) on sorbent performance to be observed.

This disclosure describes an electrospun nanofiber composite including nanofibers composed of one or more polymers and one or more amino acids incorporated throughout the nanofibers. A mean diameter of the nanofibers is typically in a range of about 300 nm to about 700 nm. A porosity of the nanofibers is typically in a range of about 0% to about 50%. The composite can be in the form of a mat.

Examples of suitable polymers include poly(vinyl alcohol), poly(ethylene oxide), poly(ethylene glycol), polyacrylamides, poly(vinyl acetate), poly(vinyl guanidine), poly(vinyl amine), and combinations thereof. Examples of suitable polymers include glycine, L-alanine, L-arginine, L-asparagine, L-aspartic acid, L-cysteine, L-glutamic acid, L-glutamine, L-histidine, L-isoleucine, L-leucine, L-lysine, L-methionine, L-phenylalanine, L-proline, L-serine, L-threonine, L-tryptophan, L-tyrosine, L-valine, L-taurine, L-sarcosine, L-selenocysteine, L-pyrrolysine, D-alanine, D-arginine, D-asparagine, D-aspartic acid, D-cysteine, D-glutamic acid, D-glutamine, D-histidine, D-isoleucine, D-leucine, D-lysine, D-methionine, D-phenylalanine, D-proline, D-serine, D-threonine, D-tryptophan, D-tyrosine, D-valine, D-taurine, D-sarcosine, D-selenocysteine, and D-pyrrolysine. A weight ratio of the one or more amino acids to the one or more polymers is typically in a range of about 0.25:1 to 1:1. In one example of an electrospun nanofiber composite, the polymer is poly(vinyl alcohol) and the amino acid is L-arginine.

Forming the electrospun nanofiber composite includes combining the one or more amino acids, the one or more polymers, and a solvent to yield a mixture, electrospinning the mixture to yield an electrospun nanofiber composite precursor, and heating the electrospun nanofiber composite precursor to form the electrospun nanofiber composite, wherein the one or more amino acids are incorporated throughout the electrospun nanofiber composite. Water is one example of a suitable solvent. In some cases, the mixture includes a surfactant. Electrospinning the mixture to yield an electrospun nanofiber composite precursor can include forming a mat.

Capturing carbon dioxide can include contacting the electrospun nanofiber composite as described herein with a fluid that includes carbon dioxide. The fluid can be a liquid or a gas (e.g., air). In some cases, contacting the electrospun nanofiber composite with the fluid includes reacting the one or more amino acids, a base, and the carbon dioxide to yield a carbamate, reacting the one or more amino acids, water, and the carbon dioxide to yield a bicarbonate salt, or both. In one example, the one or more amino acids includes L-arginine. In one example, the bicarbonate salt is a guanidinium bicarbonate salt. Contacting the electrospun nanofiber composite with the fluid can include reacting the one or more amino acids and the carbon dioxide to yield a carbamate, and reacting the carbamate and the one or more amino acids to yield a crystalline carbamate pair.

### EXAMPLES

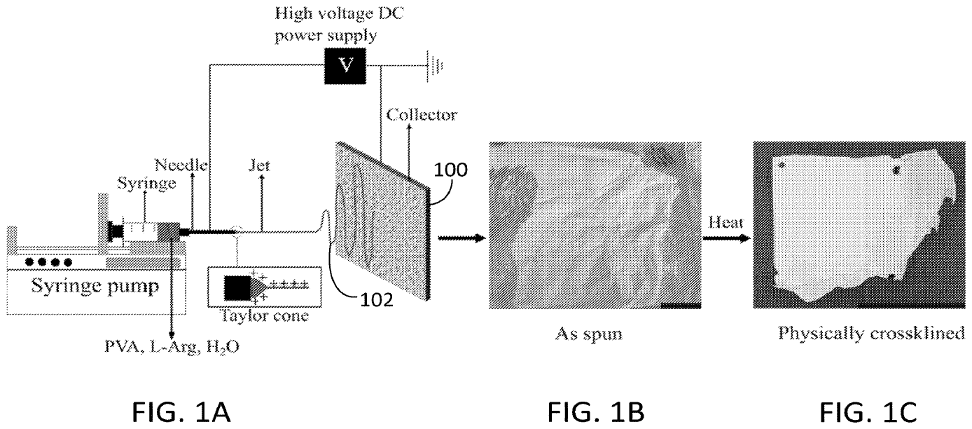

FIG. 1A shows a schematic for the fabrication of polymer-amino acid nanofiber composite mats 100 including electrospun composite nanofibers 102. During the electrospinning process, a polymer jet is extruded through a nozzle to form a pendant droplet, at least in part, as a result of surface tension, and is subjected to a strong electric field. This electric field causes a build-up of surface charges on the polymer chains, resulting in electrostatic repulsion that deforms the droplet into a Taylor cone. Then, a charged polymer jet is pulled from the high electric potential at the nozzle towards the grounded collector. The initially straight line of the jet undergoes vigorous whipping motions due to bending instabilities. The jet is further stretched to small diameters, leading to evaporation of the solvent and solidification of the polymer. The solid fibers are then deposited on the grounded collector. The morphology and size of the nanofibers produced can be controlled by changing electrospinning parameters including but not limited to voltage, distance from the nozzle to the collector, and solution concentration.

Poly(vinyl alcohol) (PVA) is a semi-crystalline, water-soluble, biocompatible polymer that is suitable for electrospinning. Poly(vinyl alcohol)-L-arginine (PVA-L-Arg) nanofiber composites were prepared by electrospinning an aqueous solution of PVA, L-Arg, and a surfactant (Triton X-100) onto an aluminum foil-covered copper plate collector. The surfactant was added to reduce the surface tension and improve the electrospinning of the PVA solution. PVA-Arg nanofibers with different loadings of L-Arg were fabricated, and the samples were labeled as PVA-Arg₂₅, PVA-Arg₅₀, PVA-Arg₇₅, and PVA-Arg₁₀₀ for L-Arg:PVA weight ratios in the solution of 0.25:1, 0.5:1, 0.75:1, and 1:1, respectively. Since PVA is a water-soluble polymer, the composites were then heated in an oven at 115 °C to physically crosslink the samples and make them resistant to humidity. FIGS. 1B and 1C show the PVA-L-Arg nanofiber composite before and after heat treatment, respectively.

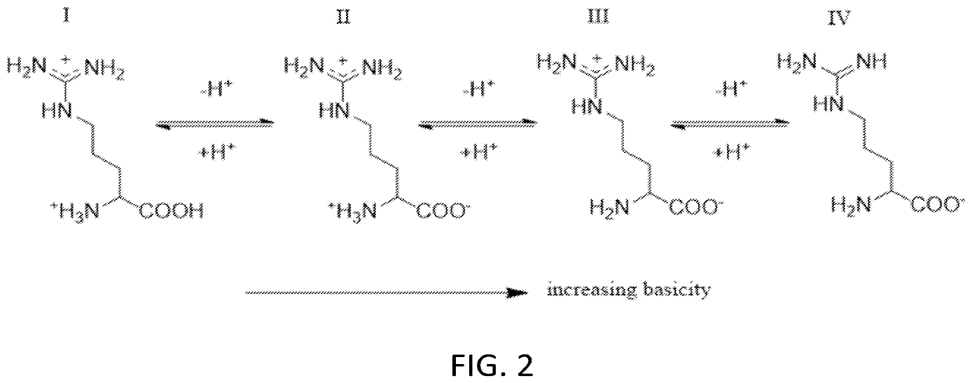

L-Arg can exist in several protonated states, as depicted in FIG. 2. L-Arg generally exists as a zwitterion (state III) in an aqueous solution. The reaction between L-Arg and CO₂ occurs when the amino acid amine is in the deprotonated state (e.g., —NH₂, as in states III and IV).

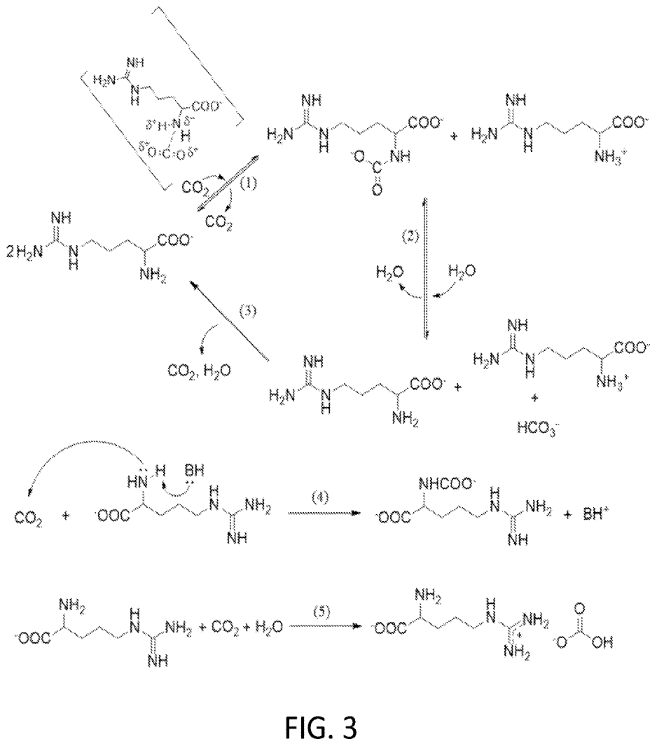

The two mechanisms depicted in FIG. 3 may explain the reaction kinetics of CO₂ sorption by L-Arg: the zwitterionic mechanism and the termolecular reaction mechanism. In the zwitterionic mechanism, the amine group of L-Arg reacts with the CO₂ to form a carbamate and zwitterion as shown in reaction (1). The carbamate in the presence of water can then react to form the bicarbonate species shown in reaction (2). The bicarbonate can give back the CO₂ via reaction (3).

In the termolecular mechanism, an amine simultaneously reacts with one molecule of CO₂ and a base (shown as B:) as shown in reaction (4). Both zwitterionic and termolecular mechanisms have been used to explain the CO₂ adsorption behavior of L-Arg. The zwitterionic mechanism has a theoretical capacity of 0.5 mol CO₂ mol⁻¹ L-Arg or 0.1263 mol CO₂ g⁻¹ L-Arg-since two L-Arg molecules are involved, while the termolecular mechanism has a theoretical capacity of 1.0 mol CO₂ mol⁻¹ Arg or 0.2526 mol CO₂ g⁻¹ Arg.

The lateral guanidinium group (high pKa of 12.48) in L-Arg can act as a base and abstract the hydrogen from the amino acid-CO₂ complex to form the carbamate shown in reaction 4. This requires only one molecule of L-Arg since the abstracted proton transfers to the lateral guanidine. This can explain the high CO₂ absorption capacity of L-Arg and can enable the chemical interaction of the amino acid with CO₂ without the addition of another base. Another possible mechanism is the reaction of the guanidinium group with CO₂ leading to the formation of guanidinium bicarbonate salts, as shown in reaction 5. A third possible mechanism is the formation of a crystalline arginine-arginine carbamate pair with the empirical formula [Arg]⁺ [ArgCO₂]⁻·2H₂O, obtained by reacting CO₂ with an aqueous solution of L-Arg. The partial positive charge on the guanidine part of L-Arg makes it a poorer nucleophile for attacking CO₂, which can explain why the amine group closer to the carboxylic acid may be involved in carbamate formation.

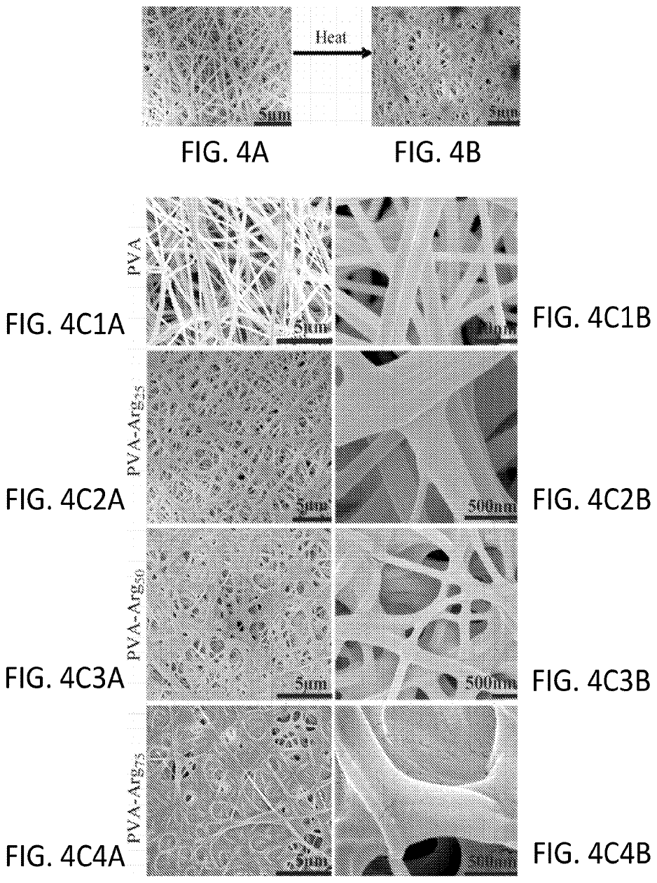

The SEM images in FIGS. 4A and 4B show that the nanofiber composite mat maintains its nanofibrous morphology after heating at 115 °C for 30 min. The high surface area afforded by the nanofiber morphology produces a large area of contact between air and L-Arg and enables fast DAC sorption kinetics. The change in the composite mat morphology and nanofiber diameter with increasing L-Arg concentration is shown in FIGS. 4C1A-4C4B. The SEM images were segmented, processed, and analyzed to obtain fiber characteristics. The mean fiber diameter and the diameter distribution increase with an increase in the L-Arg concentration. Porosity, measured as the percentage area of black pixels (pores) compared to white pixels (fibers) after SEM image segmentation, decrease with an increase in the L-Arg concentration. The porosity steadily decreases up to the PVA-Arg₅₀ and then decreases substantially when the weight ratio of L-Arg increases from PVA-Arg₅₀ to PVA-Arg₇₅. Characteristics of the nanocomposite mat are listed in Table 1. Energy-dispersive X-ray spectroscopy (EDS) analysis shows an even distribution of the L-Arg throughout the nanofiber structure.

TABLE 1
Nanofiber characteristics of various PVA-Arg nanofiber
composites obtained from SEM image analysis

| | Mean Diameter ^{a} | Porosity |
|---|---|---|
| | (nm) | (% Area) |
| PVA | 306 ± 111 | 37 |
| PVA-Arg₂₅ | 319 ± 148 | 29 |
| PVA-Arg₅₀ | 401 ± 205 | 22 |
| PVA-Arg₇₅ | 613 ± 474 | 7 |

### a) (Mean Diameter±Standard Deviation)

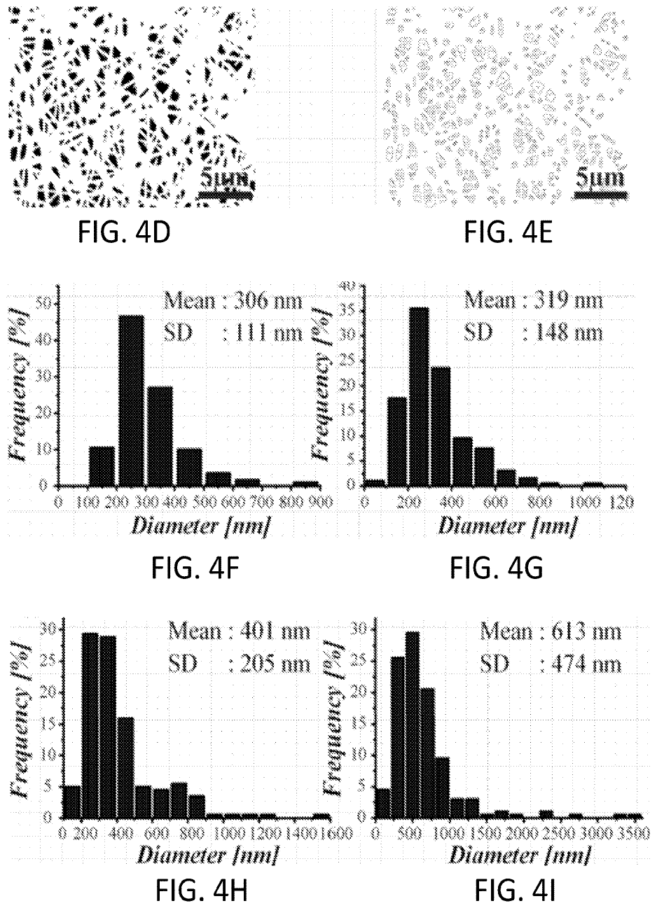

Thermogravimetric analysis (TGA) of the nanofiber composite mats with different L-Arg concentrations before and after heating is shown in FIG. 5A. The nanofiber composite mats had a marginally higher thermal stability after the physical crosslinking was performed. An increase in the degradation temperature (Ta) was also observed with an increase in L-Arg concentration. Both L-Arg and PVA follow a two-step degradation profile with similar temperature ranges for their thermal decompositions. The calculated L-Arg composition values are shown in Table 2. The PVA-Arg₂₅ and PVA-Arg₅₀ samples show a similar composition compared to the electrospinning solution concentration. The PVA-Arg₂₅ sample showed a slightly higher L-Arg content compared to the electrospinning solution concentrations.

TABLE 2
Composition Analysis

| Spinning solution | Weight | |
|---|---|---|
| Arg content | Fraction | Weight |
| w.r.t PVA | (¹H | fraction |
| (wt %) | NMR, wt %) | (TGA wt %) |
| 25 | 29.2 | 31.5 |
| 50 | 51.5 | 50.9 |

FIG. 5B shows the differential scanning calorimetry (DSC) plots for PVA-Arg nanofiber composites with different L-Arg content. The PVA control sample is a PVA nanofiber sample without any L-Arg that has been subjected to heat treatment at 115 °C for 30 min before testing. The Tₘ peak (217.8 °C) becomes smaller with increasing L-Arg concentration, indicating that the addition of L-Arg reduces the crystallinity of the PVA nanofibers (Table 3). The melting peak also shifts to a lower temperature with an increase of L-Arg concentration. The broader and weaker melting transitions with the addition of L-Arg confirm the incorporation of the L-Arg into the PVA nanofiber structures. The melting enthalpy of the PVA-Arg composites increases after heat treatment due to an increase in crystallinity. The glass transition temperature (Tg) increases upon the addition of L-Arg; however, it was noted that the PVA-Arg₂₅ had a higher Tg than the PVA-Arg₅₀. This could indicate that some of the L-Arg might not be uniformly incorporated into the nanofiber composite structure at higher concentrations.

TABLE 3
DSC thermal transitions for various PVA-Arg composite samples

| | Glass | Melting | Melting |
|---|---|---|---|
| | Transition | point - Tₘ | Enthalpy - |
| Sample | Temperature-T_{g} (°C) | (°C) | (J/g) |
| PVA | 76.9 | 227.8 | 95.9 |
| PVA AHT | 78.0 | 227.8 | 104.3 |
| L-Arg | — | 240.4 | 400.9 |
| PVA-Arg₂₅ BHT | 83.5 | 217.6 | 59.6 |
| PVA-Arg₂₅ AHT | 86.5 | 218.8 | 63.3 |
| PVA-Arg₅₀ BHT | 79.0 | 212.1 | 55.3 |
| PVA-Arg₅₀ AHT | 80.9 | 206.5 | 68.4 |

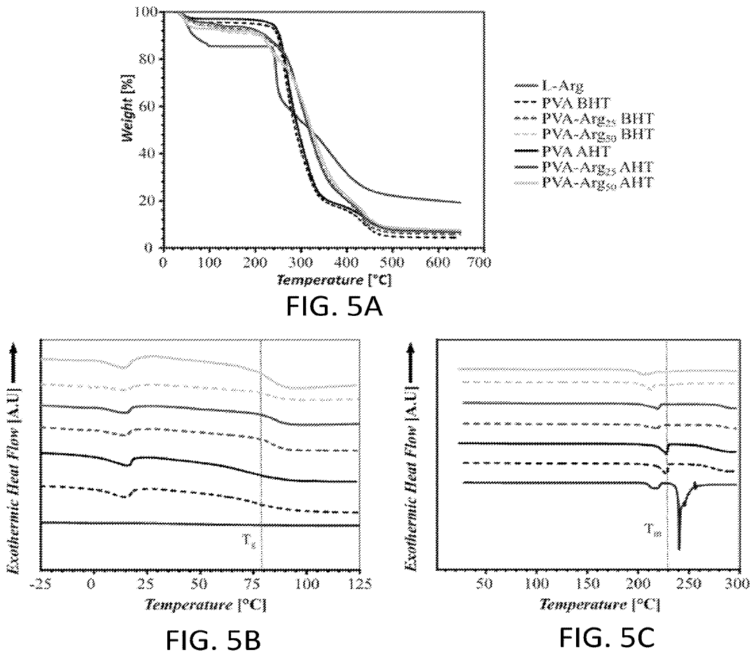

To observe the incorporation of L-Arg in the PVA nanofiber composite structure, Fourier transform infrared (FTIR) spectra of the nanofiber composites were compared to pure PVA and L-Arg as shown in FIG. 6. The FTIR spectrum for pure PVA shows a broad peak at 3380 cm⁻¹, which indicates that the stretching vibration of the —OH groups are due to intra and inter-molecular hydrogen bonding. The C—H stretching and bending vibrations are observed at 2942 cm⁻¹ and 1446 cm⁻¹, respectively. The weak absorption band at 1722 cm⁻¹ corresponds to the stretching band of C═O, while the band at 852 cm⁻¹ is attributed to the C—C stretching vibration. The broad band —OH peaks of PVA-Arg₅₀ fibers at 3348 cm⁻¹ are shifted to a lower wavenumber than the absorbance peaks exhibited by —OH of pure PVA. This may be due to strong hydrogen bonding between —OH, COOH, and NH₂ groups of the PVA and L-Arg. The narrowing and sharpening of the —OH peaks in the FTIR spectra, as seen when comparing pure PVA (3380 cm⁻¹) to heat-treated PVA-Arg samples, indicates the incorporation of L-Arg into the polymer fiber matrix. The L-Arg peaks also appear in the FTIR spectra of PVA-Arg samples, confirming incorporation of L-Arg. For example, the out-of-plane bending of the NH₂ group in L-Arg shows up as a peak at 1710 cm⁻¹. This peak also shows up in the PVA-Arg composite samples. There was no significant difference before and after heat-treating the samples, showing that no chemical change (including amide linkage formation between the PVA and Arginine) occurred during the heat treatment.

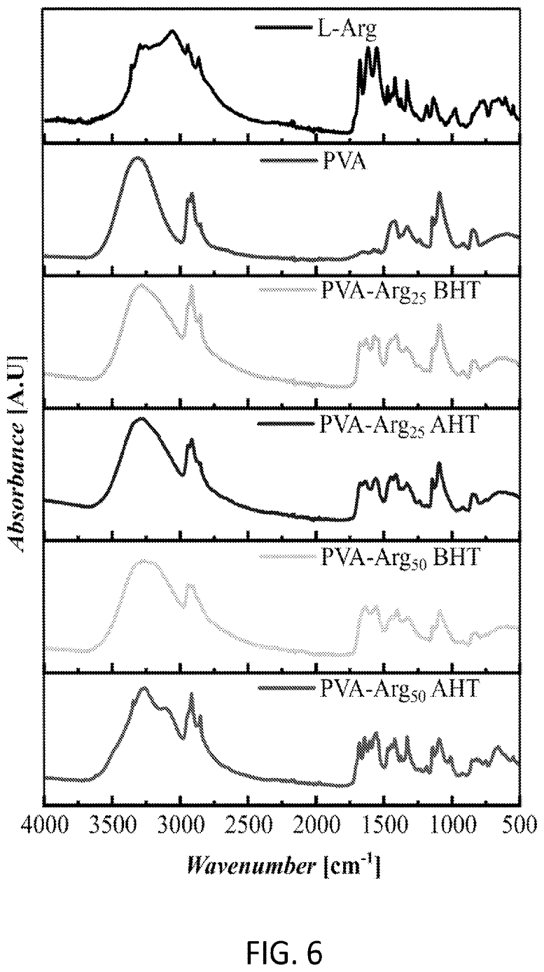

The nanofiber mats were also analyzed using ¹H-NMR spectroscopy. FIG. 7 shows the spectra at different concentrations of L-Arg in the nanofiber mats along with pure L-Arg and pure PVA. The PVA-L-Arg nanocomposite plots are a superposition of the individual PVA and L-Arg NMR spectra. The L-Arg peak at 3.11 ppm shows up in both PVA-Arg₂₅ and PVA-Arg₅₀ samples. The smaller L-Arg peak at 3.18 ppm is shifted downfield for the PVA-Arg₂₅ and PVA-Arg₅₀ samples. However, the integration ratio (2:1) between the two peaks remains the same. This indicates that the L-Arg is physically incorporated into the nanofiber samples and a lack of chemical change in the PVA and L-Arg during the heat treatment process. The downfield shift of the smaller peak is attributed to pH differences between NMR sample solutions. The concentration of L-Arg in the composite nanofiber mats obtained by ¹H-NMR spectroscopy is shown in Table 2. The composition of the PVA-Arg₂₅ sample is closer to the ratio of L-Arg and PVA fed to the system compared to the PVA-Arg₅₀ sample. The compositional data acquired by ¹H-NMR spectroscopy is more definitive and accurate compared to the TGA. The ¹H-NMR spectra were collected from samples subjected to heat treatment.

DAC performance was tested using custom-made open and closed-circuit systems. DAC can function without the need for high energy consumption equipment such as pumps by utilizing natural wind movement, allowing for passive uptake of CO₂. To simulate some of these conditions, the sample is not packed in the testing chamber and the pressure drop across the sample chamber remains low. In the closed-circuit system, a fixed volume of lab air is circulated in a closed-loop, and the CO₂ concentration in the sample chamber is measured as a function of time. Decreases in CO₂ concentration are attributed to CO₂ sorption by the sorbent and increases in CO₂ concentration correlate to CO₂ release by the sorbent. In the open-circuit system, atmospheric air with a fixed CO₂ concentration is continuously pumped into the sample chamber at a fixed flow rate. The rate of CO₂ captured by the sample is calculated from the real time difference in the inlet and outlet CO₂ concentrations combined with the gas flow rate through the chamber. This system simulates real world conditions in which ambient air continuously contacts the sorbent. The sample chamber is not packed, and the air in the sample chamber is kept in the laminar regime at a velocity of around 0.01 m s⁻¹. All tested samples, including controls, were subjected to steam activation before testing. PVA, being a hydrophilic material, may absorb some of the steam and in turn solubilize some of the L-Arg present in the nanofibers and release any CO₂ adsorbed before testing.

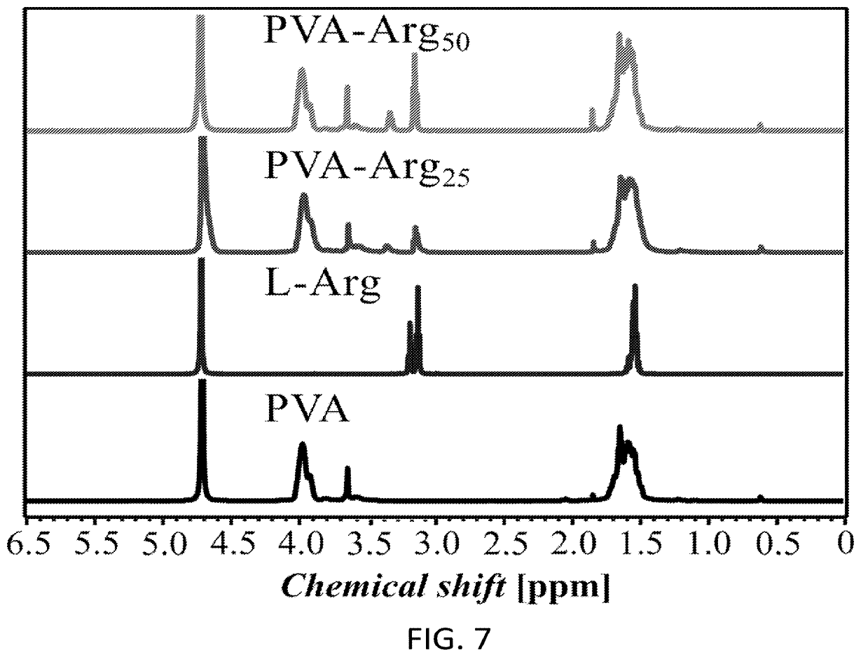

The effect on CO₂ sorption performance when incorporating L-Arg in high surface area nanofiber form factors was first tested in the closed-circuit system. All testing was done using atmospheric air, and the initial CO₂ concentration was between 400-450 ppm. The sample size was kept at 15-20 mg. L-Arg powder and PVA nanofibers without L-Arg (PVA control) were used as positive and negative controls. FIG. 8A shows that the PVA control mat has close to 0 μmol g⁻¹ passive CO₂ sorption. The L-Arg powder shows around 10 μmol g⁻¹ CO₂ sorption. The theoretical capacity of L-Arg is 2,870 μmol g⁻¹ assuming a 0.5:1 CO₂:L-Arg stoichiometry. Thus, the L-Arg powder only utilizes 0.34% of its maximum theoretical capacity. Referring to FIG. 8A, an improvement (up to 12× at 80% relative humidity (RH)) in sorption performance can be seen upon testing the PVA-Arg nanofiber composites. The increase in performance of the PVA-L-Arg nanofiber composite mats compared to bulk L-Arg can be attributed to the nanofiber morphology of the composites.

It was observed that increasing the relative humidity in the sample chamber increases the nanofiber composite sorption performance significantly. The total CO₂ uptake increases from 40 μmol g⁻¹ (20% RH) to over 120 μmol g⁻¹ (40% RH). It was observed that a further rise in humidity after 40% RH has minimal impact on performance. The increase in humidity may favor CO₂ reaction mechanisms that form bicarbonates. Furthermore, hydroxide ions in water can act as a base to create more carbamates via both the zwitterionic and termolecular reaction mechanism depicted in FIG. 2. Humidity may improve the availability of amines for CO₂ interaction. The increase in performance of the composites with increasing humidity suggests the occurrence of such favorable interactions in the disclosed system and the presence of favorable reaction pathways towards bicarbonate formation. In subsequent experiments, 20% and 80% RH were used to simulate low and high humidity conditions.

The effect of L-Arg concentration on the sorption performance was then tested using the open-circuit system. FIG. 8B shows that an increase in L-Arg concentration increased the performance of the PVA-L-Arg nanofiber composites up to a 50 wt % loading of L-Arg (PVA-Arg₅₀). A further increase in the L-Arg concentration created nanofiber composite mats that were mechanically weak and non-uniform. The higher L-Arg loading on the PVA-Arg₇₅ and PVA-Arg₁₀₀ also made them more difficult to remove from the electrospinning collector. The CO₂ sorption performance of nanofiber composite mats started to decline above L-Arg loadings present in PVA-Arg₅₀. The sorption performance follows the order PVA-Arg_{7.5}<PVA-Arg₂₅<PVA-Arg₅₀>PVA-Arg₇₅>PVA-Arg₁₀₀. The loss in performance correlates with the loss of porosity and increase in fiber diameter distribution. The loss of porosity decreases the overall surface area of contact that the nanofiber composites have with CO₂, which leads to a loss in performance. Thus, the data suggest that the lack of proper structural integrity and porosity, combined with the coating of the nanofiber surface with too much L-Arg, decreases the overall L-Arg surface area available in PVA-Arg₁₀₀ for sorption, thereby leading to the drop in performance.

The best performing composites (PVA-Arg₂₅ and PVA-Arg₅₀) were tested in the open-circuit system at a higher inlet relative humidity (i.e., 80%). As noted in the previous data, humidity improved nanofiber composite CO₂ sorption performance. FIG. 8C shows that the PVA-Arg₂₅ and PVA-Arg₅₀ composite mats exhibit higher sorption performance when the inlet air humidity is higher. CO₂ sorption was performed at 20% and 80% relative humidity levels. The performances of the composites in the open-circuit device are summarized in Table 4. The sorption rate at 80% RH is highest for the PVA-Arg₅₀ sample, followed by the PVA-Arg₂₅ sample. The values of 312 μmol g⁻¹ (PVA-Arg₂₅) and 431 μmol g⁻¹ (PVA-Arg₅₀) of adsorbed CO₂ equate to 0.271 mol CO₂ mol⁻¹ L-Arg (PVA-Arg₂₅) and 0.225 mol CO₂ mol⁻¹ L-Arg (PVA-Arg₅₀). The exposure to higher humidity translates to approximately 1.5 times improvement in theoretical capacity utilization for PVA-Arg₅₀. The increase in performance on exposure to higher humidity may be related to the availability of more favorable reaction pathways that form bicarbonate ions.

TABLE 4
Open-circuit CO₂ sorption performance of PVA-L-Arg nanofiber composites
with various L-Arg concentrations calculated over a period of 2 h

| | 20% RH | | | | | 80% RH | |
|---|---|---|---|---|---|---|---|
| | PVA- | PVA- | PVA- | PVA- | PVA- | PVA- | PVA- |
| Sample | Arg_{7.5} | Arg₂₅ | Arg₅₀ | Arg₇₅ | Arg₁₀₀ | Arg₂₅ | Arg₅₀ |
| L-Arg content ^{(a)} | 6.9 | 20 | 33.3 | 42.8 | 50 | 20 | 33.3 |
| (wt %) | | | | | | | |
| Capacity | 156 | 197 | 272 | 191 | 18 | 312 | 431 |
| (μmol g⁻¹) | | | | | | | |
| Avg. sorption rate | 0.022 | 0.027 | 0.038 | 0.027 | 0.002 | 0.043 | 0.060 |
| (μmol g⁻¹ s⁻¹) | | | | | | | |

^{(a)} L-Arg content is calculated as a percentage of total mass of sample.

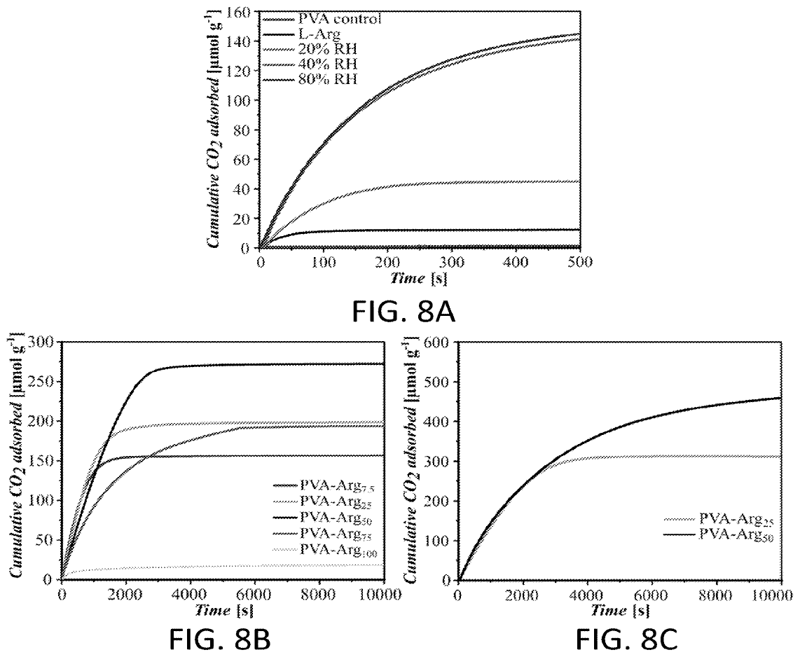

The desorption and sorption performance of the PVA-Arg₅₀ at 80% relative humidity was further analyzed utilizing a custom-made test apparatus that allows sorption and desorption to be done in the same test system. The sorption performance of the composite mats in an open-circuit format after CO₂ desorption is shown in FIGS. 9A and 9B. The performance was higher after activation, using a custom-made steam treatment system, since the steam activation of the fibers is more efficient. The sample chamber was submerged in a heated water bath while passing steam saturated air through the sample chamber, allowing isothermal desorption and facilitating uniform contact of steam with the sample. The real-time desorption progress was monitored using an infrared gas analyzer (IRGA). The sample was then transferred in its sample holder into the open circuit device. There was no contact with outside air during the transport of the sample into the open circuit sample testing chamber, although this would have only a small effect on the measured capacity. The composite mats absorbed a total of 542 μmol g⁻¹ of CO₂ over a span of 2 h when exposed to a continuous stream of air. The desorption was a faster process (quantified by the faster desorption rate), and the composite mat released 50% and 75% of adsorbed CO₂ in 360 s and 610 s of steam exposure respectively. The amount of CO₂ adsorbed in the open-circuit system is comparable to the CO₂ desorbed in the desorption system. There was a loss in performance of the nanofiber composite after the 1^{st} cycle. This is associated with the soluble nature of the PVA support in steam, and led to a loss of mass, structural integrity, and leeching.

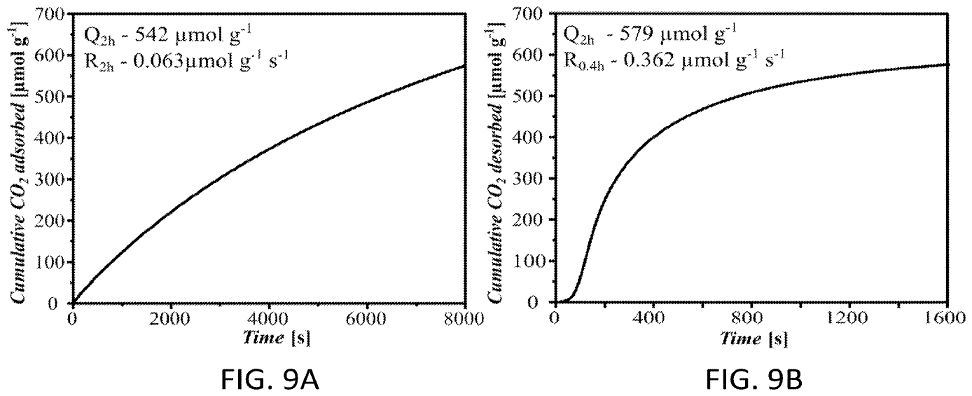

The simulation of the kinetics of adsorption for the PVA-Arg nanofiber composites was done using the pseudo-first order, pseudo-second order and the Avrami kinetic models. The kinetic model fits for the PVA-Arg₂₅ and PVA-Arg₅₀ samples, previously tested at 100% humidity in the open circuit, are plotted in FIGS. 10A-10C and the fitting parameters are listed in Table 5. For both L-Arg concentrations, the Avrami model closely fits the observed data. The predicted equilibrium capacity from the Avrami fit is also close to the observed experimental data. The pseudo-second order model performed the worst, with the predicted capacity significantly overshooting the actual observed value. The predicted adsorption curves of both the pseudo-first order and the pseudo-second order models deviated from the experimental data close to the initial and equilibrium time scales of adsorption. The correlation coefficients R² for pseudo-first order and pseudo-second order vary from 0.9266-0.9991, whereas the R² for the Avrami fit stays consistently above 0.9900. These correlation coefficients are observed in samples tested in the open circuit at 20% RH. Therefore, the Avrami equation describes the adsorption characteristics of PVA-Arg nanofiber composites. The reaction order remained close to 1 for samples tested at 20% and 80% RH, suggesting that the probability of adsorption in the nanofiber composite samples remains homogenous throughout the sample. This can be explained by the porous nanofibrous morphology of the composite which allows for effective contact of the L-Arg with air. The variation of a between samples possibly indicates the availability of multiple reaction pathways of CO₂ sorption.

TABLE 5
Parameters of kinetic simulation for PVA-Arg nanofiber
composites tested in the open circuit at 80% RH

| Model | Parameters | PVA-Arg₂₅ | PVA-Arg₅₀ |
|---|---|---|---|
| pseudo-first order | qₑ(exp) | 311.0 | 479.3 |
| | qₑ(fit) | 315.5 | 476.16 |
| | k_{f} | 6.84 × 10⁻⁴ | 3.392 × 10⁻⁴ |
| | R² | 0.9846 | 0.9991 |
| pseudo-second order | qₑ(fit) | 352.1 | 583.1 |
| | kₛ | 2.75 × 10⁻⁶ | 6.31 × 10⁻⁷ |
| | R² | 0.9266 | 0.9962 |
| Avrami | qₑ(fit) | 312.5 | 482.9 |
| | kₐ | 6.64 × 10⁻⁴ | 3.31 × 10⁻⁴ |
| | n | 1.33 | 0.93 |
| | R² | 0.9989 | 0.9999 |

The PVA-L-Arg nanofiber composites show better CO₂ sorption performance in comparison with bulk L-Arg, due at least in part to the high surface area of the nanofiber morphology. This increases the L-Arg that comes into contact with atmospheric CO₂. Based on L-Arg content, the 2 h CO₂ sorption capacity and average sorption rate follow the trend PVA<L-Arg<PVA-Arg_{7.5}<PVA-Arg₂₅<PVA-Arg₅₀>PVA-Arg₇₅>PVA-Arg₁₀₀. An increase in fiber diameter distribution and a reduction in porosity led to a decrease in CO₂ sorption performance (which also corresponds to higher L-Arg concentrations). The nanofiber composites also showed better CO₂ sorption performance under high humidity conditions with the PVA-Arg₅₀ performing the best at high humidity. The increased humidity may lead to increased bicarbonate formation thereby improving CO₂ sorption capacity.

### Materials

Poly(vinyl alcohol) (PVA-M_{w} 89,000-98,000), 99+% hydrolyzed, and L-Arg were purchased from Sigma Aldrich, USA. Triton X-100 (p-tertiary-octylphenoxy polyethyl alcohol), a nonionic surfactant to aid electrospinning, was purchased from Alfa Aesar. Lab deionized water (DI) with a conductivity of 0.5 μS cm⁻¹ was used to dissolve the polymer and L-Arg.

### Characterization

Scanning Electron Microscopy (SEM) was performed using the Nova 200 Focused Ion Beam (FIB) SEM. The SEM images were captured at 5-10 kV gun voltage and were used to characterize the morphology of the nanofibers. An EDAX detector on the Zeiss Auriga FIB SEM was used to obtain Energy Dispersive X-ray Spectroscopy (EDS). EDS was used to characterize the distribution of L-Arg in the composite system. Thermal transitions and decompositions of the composite samples were characterized using a Q2000 TA instrument Differential Scanning calorimeter (DSC) and TA Thermogravimetric Analyzer TGA5500, respectively. The DSC curves shown are from the 2^{nd} heating cycle at a ramp rate of 10 °C/min. Since the thermal degradation temperature of PVA is close to the melting temperature, the maximum temperature of the 1^{st} heating cycle was limited to 200 °C. This was followed by an isothermal hold for 10 min at 200 °C. For the cooling cycle, the sample was cooled down to −80 °C at a rate of 30 °C/min. The lower temperature 1^{st} heating cycle facilitates the preservation of the fiber structure.

FTIR spectra (400-4000 cm⁻¹) were obtained with a Nicolet™ iS™ spectrometer at 4 cm⁻¹ resolution and averaged over 64 scans. Raman spectra were obtained from a custom-built Raman spectrometer at Eyring Materials Center at Arizona State University (ASU). The samples were excited using a 150 mW Coherent Sapphire SF laser with a 532 nm laser wavelength. The detector used was an Andor 750 spectrometer combined with an iDus Backthinned CCD detector with a spectral resolution of 1 cm⁻¹. The spectra were obtained using an exposure of 30 s with the laser power set to 50-74 mW. ¹H NMR spectroscopy was performed on a Bruker Advance III 400 MHz spectrometer using deuterated water (D₂O) to determine nanofiber composite composition. Samples were prepared as 20 mg of dried polymer dissolved in 0.7 g deuterated water. Chemical shifts are given in ppm downfield from 2,2-Dimethyl-2-silapentane-5-sulfonic acid (DSS). Since the samples were physically crosslinked, complete dissolution of the mats in D₂O was ensured by heating the solution to 80 °C.

Image analysis was done using Image J software. Average fiber diameter was calculated using the average of 300 fiber diameters obtained from SEM images. The statistical region merging plugin was then used to segment regions of the SEM image with similar intensity and color. Thresholding of the image was performed to aid edge detection and the analyze particle tool was used to obtain pore size characteristics. The porosity was then obtained as the area fraction between black and white pixels.

Composition analysis was adopted from the protocol described by Dr. Dennenwaldt in Mettler Toledo UserCom51. It is assumed in the analysis that each component in the PVA-L-Arg composite system exhibits the same decomposition behavior as that of the individual component. Thus, the TGA curve of PVA-Arg (m(T)_{PVA-Arg}) can be expressed as a linear combination of the individual TGA curves of PVA (a(T)_{PVA}) and L-Arg (b(T)_{Arg}) as given by Eq. 1.

m(T)_{PVA-Arg}=xa(T)_{PVA}+yb(T)_{Arg} (1)

Furthermore, the sum of individual mass fractions adds up to 1, and both x and y are positive numbers.

x+y=1 (2)

x,y≥0 (3)

Using Eqs. 1, 2, and 3, the sum of quadratic deviations can be minimized between the measured value of TGA data and the calculated value. The Excel solver was used to perform the operation.

### Preparation of PVA-Arg Nanofiber Composite Mats

To make the PVA-Arg₅₀ composite mats, a 14 wt % PVA solution in deionized (DI) water is first made by stirring PVA (1.4 g) in DI water (8.6 g) in an oil bath at 90 °C. The solution is allowed to completely dissolve for 2 h. A 25 wt % L-Arg solution is prepared by heating L-Arg (5 g) in DI water (15 g). To obtain a 50 wt % (0.5:1 wt.:wt. of Arg:PVA, PVA-Arg₅₀) solution, 2.8 g of the 25 wt % L-Arg solution is added and stirred for 30 min until a homogenous solution is obtained. A couple of drops (~170 mg) of Triton X-100, a surfactant, is added to the solution, and the mixture is fed into a 10 mL BD syringe mounted on a KDS 100 syringe pump. The Triton X-100 reduces the surface tension of the solution and facilitates the formation of a stable Taylor cone. The flow rate is set to 0.8 mL h⁻¹. For electrospinning, the voltage is set to 22 kV, the distance to the collector is 17 cm, and the nozzle used is 18 gauge (0.838 mm inner diameter). The collector consists of a copper plate wrapped with aluminum foil.

After electrospinning, the nanofiber composite mat is peeled off the collector and heated at 115 °C for 30 min to physically crosslink the PVA. Hydrogen bonding between the hydroxyl groups of PVA leads to the formation of small crystallites that serve as crosslinks that hold the polymer network together. Heat treatment leads to an increase in crystallinity and better stability of the nanofibers in water.

### Direct Air Capture (DAC) Testing

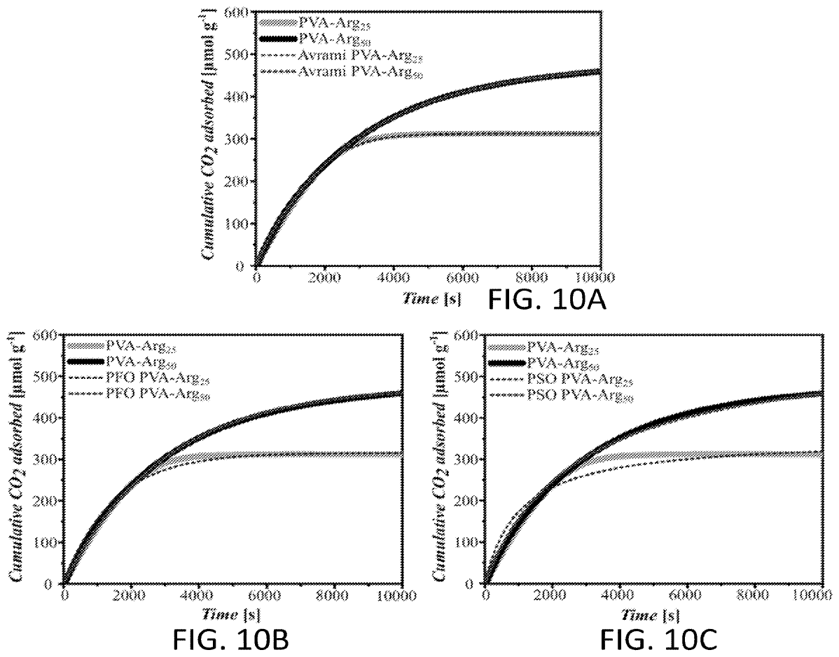

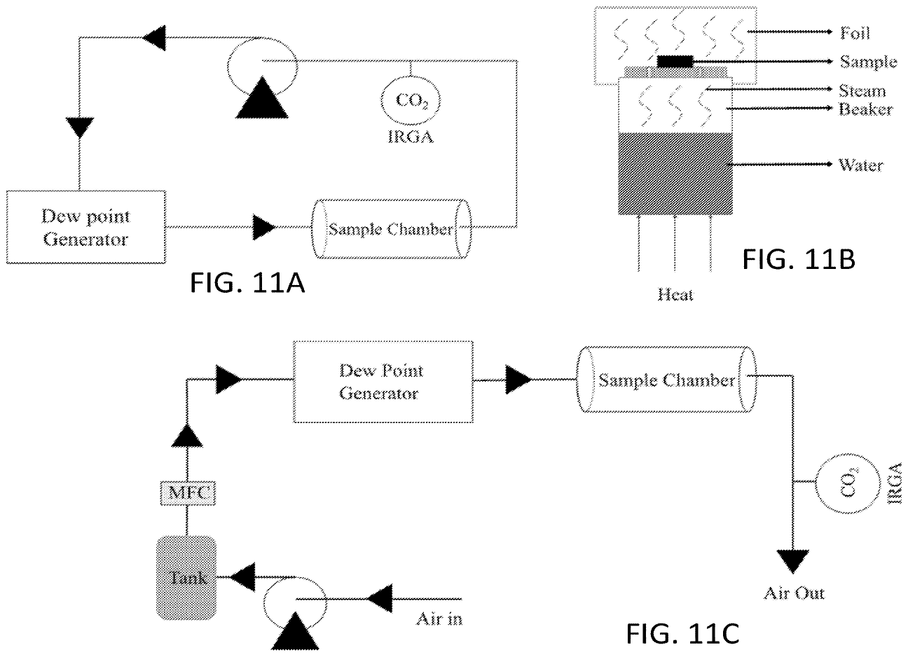

The performance of the nanofiber composites in the DAC of CO₂ is quantified using two systems shown in FIGS. 11A-11C. The closed-circuit system shown in FIG. 11A includes a pump that circulates air through the sample testing chamber and a humidity control chamber that uses a Peltier element to either release water vapor or condense out water vapor. The system is closed once the sample is placed inside the sample chamber. No air enters or leaves the system. Binding or release of CO₂ is measured in real time by monitoring the CO₂ content of the circulating air as it passes through an inline infrared gas analyzer (IRGA), a LiCOR 850. The initial baseline CO₂ concentration in the closed system is measured and recorded as C_{b}. The CO₂ concentration of the closed system reaches an equilibrium value Ce at time t. The total CO₂ adsorbed (Qₑ) by the sample is given by Eq. 10. This can be converted to cumulative performance per gram by using Eq. 11, where Vₛ is the volume (mL) of the sample chamber, V_{M} is molar volume (mL) of 1 mole of air (assumed to be at STP), and m is the sample mass (PVA+L-Arg mass).

$${Q}_{e} [ ppm ] = {C}_{b} - {C}_{e} \qquad ( 4 )$$

$${Q}_{e} [ μ mol {g}^{- 1} ] = \frac{{Q}_{e} [ ppm ] * {V}_{s}}{{10}^{6} * {V}_{M} * m} \qquad ( 5 )$$

The open-circuit system shown in FIG. 11C is designed to mimic real world DAC performance. To minimize fluctuations of CO₂ air in an indoor environment, ambient lab air is first filled into a tank using a compressor. During the experiment, air flows from the tank through a mass flow controller, a Li-Cor 610 dew point generator, the sample chamber, and an IRGA before it is vented to the ambient air. The gas flow rate is controlled to a fixed rate of 0.5 L min⁻¹. CO₂ and water vapor content of the inflow stream are constant throughout the experiment. CO₂ and water vapor concentration downstream of the sample chamber are measured continuously. This device enables the measurement of adsorption performance of materials upon continuous exposure to an air stream with the inlet concentration of the sample chamber remaining equal to the CO₂ concentration in the lab (400-450 ppm). The concentration depends on the ambient conditions in the laboratory at the time the gas reservoir is filled. The inlet CO₂ concentration (Cin) is measured before the sample is placed in the sample chamber and is averaged over a time period of at least 60 s. The IRGA records the outlet CO₂ concentration (Cₒᵤₜ(t)) of air coming from the sample every second. The rate of CO₂ sorption (C_{ads}(t)) by the sample is calculated from the difference between the inlet and outlet CO₂ concentration (Eq. 6). The cumulative CO₂ adsorbed (Q(t)) is the total CO₂ adsorbed over a time t (Eq. 7).

$${C}_{ads} ( t ) [ ppm ] = {C}_{in} - {C}_{out} ( t ) \qquad ( 6 )$$

$$Q ( t ) [ ppm ] = {\int }_{0}^{t} {C}_{ads} dt \qquad ( 7 )$$

The IRGA measures CO₂ concentrations in ppm. The cumulative CO₂ adsorbed (Eq. 8) by the sample in μmol g⁻¹ is obtained as follows:

$${Q}_{ads} [ μ mol {g}^{- 1} ] = \frac{{Q}_{ads} [ ppm ] * F}{m * {V}_{M}} \qquad ( 8 )$$

where F is the flow rate (ml s⁻¹) of air in the open-circuit device, V_{M} is the molar volume (mL) of 1 mole of air (assumed to be at STP), and m is the mass (g) of the sample.

The average sorption rate is calculated over a time period t, Rₜ (μmol g⁻¹ s⁻¹) by Eq. 9 as:

$${R}_{t} [ μ mol {g}^{- 1} {s}^{- 1} ] = \frac{{Q}_{ads} [ ppm ]}{{\int }_{0}^{t} tdt} \qquad ( 9 )$$

To test the desorption and adsorption characteristics of samples, a custom-made device was used. The system consists of three chambers that are interconnected. The first chamber contains water that is heated up using a water bath at a set temperature to produce steam at subatmospheric partial pressure. Atmospheric air is fed continuously to help the steam reach the second chamber where the sample is kept. This second chamber is also kept in a water bath to control the temperature of steam desorption. Finally, the air stream exits into a third chamber kept in an ice bath to knock out excess humidity that otherwise would condense out in the lines or the infrared gas analyzer. The air then passes through an IRGA to obtain real-time CO₂ concentration data. The modular nature of the device allows the removal of the sample chamber after desorption and its attachment directly to the open circuit testing area, which helps to prevent the sample from coming into contact with the atmosphere during open circuit testing.

Unless stated otherwise, all the samples mentioned above were steam treated using a simple steam generator consisting of a beaker filled with water heated on a hot plate shown in FIG. 11B. The top of the beaker is covered with a sample holder that has holes to let the steam come into contact with the sample. The steam activation times for closed and open circuit systems were 5 and 10 min, respectively. The longer steam activation time for the open circuit testing was used due to the larger sample size. However, it was noted that longer activation times led to a loss in structural and morphological integrity of the nanofiber composites. Once the sample is placed in the sample holder, the whole set-up is covered with aluminum foil to limit the escape of steam.

### Kinetics of Adsorption

The experimental data obtained from the open circuit was fitted to pseudo-first order (Eq. 10), pseudo-second order (Eq. 11), and the Avrami kinetic models (Eq. 12):

$${Q}_{t} [ μ mol {g}^{- 1} ] = {Q}_{e} ( 1 - {e}^{- {k}_{f} t} ) \qquad ( 10 )$$

$${Q}_{t} [ μ mol {g}^{- 1} ] = {Q}_{e} * \frac{{Q}_{e} {k}_{s} t}{( 1 + {Q}_{e} {k}_{s} t )} \qquad ( 11 )$$

$${Q}_{t} [ μ mol {g}^{- 1} ] = {Q}_{e} ( 1 - {e}^{- {( {k}_{a} t )}^{n}} ) \qquad ( 12 )$$

where Qₜ is the amount of CO₂ adsorbed at a given time t and Qₑ is the CO₂ sorption capacity at equilibrium. kⱼ, kₛ and kₐ are the rate constants for pseudo-first order, pseudo-second order and Avrami models respectively and n is the order of the reaction as described by the Avrami model. The fit quality of the models in predicting experimental data wa assessed by comparing the experimental equilibrium capacity with that predicted by the model and by using the coefficient of determination R². The fitting parameters were obtained via nonlinear regression using ORIGIN software.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. An electrospun nanofiber composite comprising:
nanofibers comprising one or more polymers; and
one or more amino acids incorporated throughout the nanofibers.

2. The composite of claim 1, wherein the one or more polymers comprise poly(vinyl alcohol), poly(ethylene oxide), poly(ethylene glycol), polyacrylamides, poly(vinyl acetate), poly(vinyl guanidine), or poly(vinyl amine).

3. The composite of claim 2, wherein the one or more amino acids comprise glycine, L-alanine, L-arginine, L-asparagine, L-aspartic acid, L-cysteine, L-glutamic acid, L-glutamine, L-histidine, L-isoleucine, L-leucine, L-lysine, L-methionine, L-phenylalanine, L-proline, L-serine, L-threonine, L-tryptophan, L-tyrosine, L-valine, L-taurine, L-sarcosine, L-selenocysteine, L-pyrrolysine, D-alanine, D-arginine, D-asparagine, D-aspartic acid, D-cysteine, D-glutamic acid, D-glutamine, D-histidine, D-isoleucine, D-leucine, D-lysine, D-methionine, D-phenylalanine, D-proline, D-serine, D-threonine, D-tryptophan, D-tyrosine, D-valine, D-taurine, D-sarcosine, D-selenocysteine, or D-pyrrolysine.

4. The composite of claim 3, wherein a weight ratio of the one or more amino acids to the one or more polymers is in a range of about 0.25:1 to 1:1.

5. The composite of claim 4, wherein the amino acid is L-arginine and the polymer is poly(vinyl alcohol).

6. The composite of claim 1, wherein the composite is in the form of a mat.

7. The composite of claim 1, wherein a mean diameter of the nanofibers is in a range of about 300 nm to about 700 nm.

8. The composite of claim 1, wherein a porosity of the nanofibers is in a range of about 0% to about 50%.

9. A method of forming an electrospun nanofiber composite, the method comprising:
combining one or more amino acids, one or more polymers, and a solvent to yield a mixture;
electrospinning the mixture to yield an electrospun nanofiber composite precursor; and
heating the electrospun nanofiber composite precursor to form the electrospun nanofiber composite, wherein the one or more amino acids is incorporated throughout the electrospun nanofiber composite.

10. The method of claim 9, wherein the one or more amino acids comprise glycine, L-alanine, L-arginine, L-asparagine, L-aspartic acid, L-cysteine, L-glutamic acid, L-glutamine, L-histidine, L-isoleucine, L-leucine, L-lysine, L-methionine, L-phenylalanine, L-proline, L-serine, L-threonine, L-tryptophan, L-tyrosine, L-valine, L-taurine, L-sarcosine, L-selenocysteine, L-pyrrolysine, D-alanine, D-arginine, D-asparagine, D-aspartic acid, D-cysteine, D-glutamic acid, D-glutamine, D-histidine, D-isoleucine, D-leucine, D-lysine, D-methionine, D-phenylalanine, D-proline, D-serine, D-threonine, D-tryptophan, D-tyrosine, D-valine, D-taurine, D-sarcosine, D-selenocysteine, or D-pyrrolysine.

11. The method of claim 9, wherein the one or more polymers comprise poly(vinyl alcohol), poly(ethylene oxide), poly(ethylene glycol), polyacrylamides, poly(vinyl acetate), poly(vinyl guanidine), or poly(vinyl amine).

12. The method of claim 9, wherein the solvent comprises water.

13. The method of claim 9, wherein the mixture further comprises a surfactant.

14. The method of claim 9, wherein a weight ratio of the one or more amino acids to the one or more polymers is in a range of about 0.25:1 to 1:1.

15. The method of claim 9, wherein electrospinning the mixture to yield an electrospun nanofiber composite precursor comprises forming a mat.

16. A method of capturing carbon dioxide, the method comprising:
contacting the electrospun nanofiber composite of claim 1 with a fluid comprising carbon dioxide.

17. The method of claim 16, wherein contacting the electrospun nanofiber composite with the fluid comprises reacting the one or more amino acids, a base, and the carbon dioxide to yield a carbamate.

18. The method of claim 16, wherein contacting the electrospun nanofiber composite with the fluid comprises reacting the one or more amino acids, water, and the carbon dioxide to yield a bicarbonate salt.

19. The method of claim 18, wherein the one or more amino acids comprise L-arginine, and the bicarbonate salt comprises a guanidinium bicarbonate salt.

20. The method of claim 16, wherein contacting the electrospun nanofiber composite with the fluid comprises:
reacting the one or more amino acids and the carbon dioxide to yield a carbamate; and
reacting the carbamate and the one or more amino acids to yield a crystalline carbamate pair.

21. The method of claim 20, wherein the one or more amino acids comprise L-arginine.
